(19) United States
(12) Patent Application Publication
(10) Pub. No.: US 2023/0279894 A1
(43) Pub. Date: Sep. 7, 2023

(54) DUAL SIDED FASTENER, CUSTOM BIT ATTACHMENT SYSTEM, AND METHOD OF USING SAME

(71) Applicants: Mario BELLAVITI, Woodland Park, CO (US); Sandra Catherine BELLAVITI, Woodland Park, CO (US)

(72) Inventors: Mario BELLAVITI, Woodland Park, CO (US); Sandra Catherine BELLAVITI, Woodland Park, CO (US)

(21) Appl. No.: 17/686,579

(22) Filed: Mar. 4, 2022

(51) Int. Cl. F16B 35/04

(52) U.S. Cl. CPC F16B 35/044

(57) ABSTRACT

The dual-sided fasteners as described include the screw-nail fasteners and screw-screw fasteners, and cooperating custom bit tool attachments to insert the dual-sided fasteners. The uniquely designed drill bit tool has a hollow space in the center in which the protruding screw or nail can fit inside allows the crowned shaped tip of the drill bit to reach the screw head and have an interlocking connection with the notched of the screw head. The combined use of the dual sided fasteners and cooperating custom bit tool attachments allow the construction of blind joins.

### FIELD OF THE INVENTION

The present invention relates generally to the field of expanded, threaded, driven, headed, tool-deformed or locked-threaded fasteners and holders, pushers, or setters for driven-type fasteners. Specifically, to a dual or double ended fastener having either two screw threads or a screw thread and a nail, more specifically to a dual or double ended fastener and custom bit attachment for inserting the fastener.

### BACKGROUND

Any discussion of the related art throughout the specification should in no way be considered as an admission that such related art is widely known or forms part of common general knowledge in the field.

Numerous double-ended fasteners are known, but all have a variety of shortcomings. The advantage of the currently disclosed fasteners and methods, over the traditional fasteners and methods, is that the fasteners are not visible on the outside of the object being constructed. Therefore, the use of the novel fasteners provide a sturdy connection for woodworking and other construction industries. The fasteners can be used to connect materials including but not limited to wood, wood composites, concrete and dry wall with optional use of wall anchors, they are quick and easy to use and improve the look of the finished product.

U.S. Pat. No. 6,679,668 (Martin) discloses a double-ended fastener. The fastener and an installation tool are disclosed. The fastener is double-ended and allows two opposed items to be joined. The fastener also produces a blind joint, so that the fastener itself is invisible after the joint has been formed. An accompanying installation tool assists in installing one end of the fastener. The installation tool assists in screwing the fastener into a member. Preferably the installation tool includes a contour, shape or surface disposed on a first end that is capable of torquing the fastener. Preferably the installation tool is capable of grasping fastener by meshing with the grasping portions, is able to twist the screw into the member. This typically includes two or more projections, one of which is the nail. This device does produce a blind joint, but the projections that produce the torquing force can easily be damaged, if the projections break off or bend, the device will not function as intended. Also, the upper end of the device is not configured to cooperate with a drill or multi-bit screwdriver.

CA Patent Application No. 2,737,807 (Klaus) discloses nail screws, twin spikes and twin nails. The invention provides an improved use of using screws, spikes and nails in joining pieces of wood. The intent of the devices is to use a simple procedure to join separate pieces of wood using the nail screw or twin spike or twin nail. This is accomplished by using a drill and bit as the primary method by drilling the nail screw end into the wood. The secondary method would be to hammer the twin spike or twin nail into the first wood piece using an application tool that is applied over the shank of the nail or spike connecting with one side of the nail or spike head. The application tool is a sleeve of material that can protect a first end of the fastener as the tool is being hammered to drive the second end of the fastener into a surface.

U.S. Application No. 2007/0267555 (Signor) discloses handy pins, handy tacks; and double pointed tacks. The invention may be used to fasten or anchor lightweight, three-dimensional objects such as lettering, numbers and symbols, party and holiday decorations, arts and crafts, teaching and learning aids, informational displays, and other penetrable, three-dimensional objects, fastening these kinds of objects to surfaces such as bulletin boards, gypsum wallboard surfaces, corkboards, wooden surfaces, or to other penetrable objects or surfaces by being pressed like standard pushpins, screwed, or pressed and twisted into the objects or surfaces to be joined, depending on the types of materials being fastened or anchored. The handy pins are intended for, but not limited to, indoor uses in homes, places of business, offices, schools, libraries and other public, governmental or private institutions or facilities, however they are not intended for use outdoors and in the woodworking and construction industries. Moreover, the handy pins, and the bit used to insert the handy pins, are not designed such that the double-sided fastener cannot be seen when used to connect two objects.

U.S. Application No. 2019/0063479 (Eisenmann) discloses a double-sided fastening device. The elongate double sided construction fastener has a first end and a second end separated by at least one flange, and the first end and second end can be nails, screws, or any other fastener, the same or different. In an embodiment where one end of the fastener is a screw, the flange has two notches, equally spaced along the circumference of the flange for engagement with tines of a tool suitable for use in inserting or removing the screw. In this alternative embodiment, the double-sided fastening device has a first end comprising a nail head and the second end comprising a screw. In this situation a specialized tool is employed to drive the screw into the material to be fastened. The tines of the tool engage with notches positioned on opposite sides of flange. Engagement of tines with flange permit rotation to the fastening device to thereby drive the screw into the material. In a further alternative embodiment, a cylindrical tool useful for driving or screwing the first side of the fastening device into the material being fastened, wherein the flange is in the form of hexagon, and one end of the fastener is a bolt, wherein the flange is suitable for receiving or otherwise engaging with a wrench for inserting or removing the fastener. The drawbacks of this fastener and device include the design not being capable of countersinking the fastener into the first surface to be fastened. Also, the two-tined fork tool extends beyond the notches in the flange (FIGS. 9), thereby potentially damaging the surface into which it is being driven. Moreover, the upper end of the fastening tool is not configured to be driven by a drill, the upper surface is configured to be struck with a hammer.

DE Patent No. 2,030,544 (Klaus) discloses a nail that has a nail at the front and a nail at the rear, with a drive-in rectangular plate inserted in the middle of the double point, and a hardened and magnetized drive-in bolt which can be slipped over part of the double nail to allow it to be driven in by the hammer. The double nail can be hammered in with the impact bolt, which is placed over part of the double nail, by hitting the impact bolt with a hammer. The nail-screw combination, the impact bolt, is slipped over the screw part of the double pointed, the nail screw can be driven in by hitting the impact bolt with a hammer. If the screw part is to be screwed into the object/wall, a screw-in split pin must be used, which is clamped into the drill or screwdriver. Shortcomings include the impact bolt being visible and thereby not forming a tight flush connection between the two surfaces to be connected. Furthermore, when using a drill or screwdriver to drive the screw into the first surface, additional tool parts are required in order secure the fastener to the device, such as a split pin.

U.S. Pat. No. 5,743,693 (Sobotker) discloses a double-ended nail driving system. The system securing two boards together without scarring a surface of the boards by securing a conventional fastener into the surface of the boards. The inventive device includes a double-ended nail having a center flange, an elongated cylinder having an elongated cavity projecting into an end for removably receiving an end of the double-ended nail, and a lower flange attached to the end for engaging the center flange of the double-ended nail. The lower flange engages the center flange thereby allowing the user to tap upon an opposite end with a conventional hammer thereby penetrating the double-ended nail into the board within dulling a sharpened end of the double-ended nail. The present invention further reduces the amount of scarring normally associated with conventional fasteners securing the two boards together. This nail driving system can only be used with double-ended nail fasteners, and in not configured to accommodate a screw-nail or double screw fastener.

U.S. Pat. No. 7,905,698 (Liu) discloses two-way nails, two-way screws and their mounting tools. The present invention provides mounting members useable for fastening two objects together and their mounting tools. In one embodiment, the mounting member includes a first tapered tip and an opposite, second tapered tip defining a shank therebetween, where the shank has an exterior surface and a structure formed on the exterior surface. The tools include a first holding member, a second holding member, a first spring, a second spring, a bar and a handle. Each of the first and second springs has a contracted position and an expended position. The tools are operably in a locking position in which the first and second springs are in their contracted positions and a releasing position in which the first and second springs are in their expended positions. With this tool, a user can easily grab the narrow middle-section of the narrow middle-section/neck of the nails or even screws shown. These tools allow a hammer to hit the top part for nailing a two-way nail. This tool is not capable of driving a screw threaded portion of a two-way screw, or screw-nail into a surface, it is designed to secure the fastener in position while a hammer is used to drive in a nail without damaging the second end of the fastener.

WO Application No. 2014/105416 (Simonin) discloses a double headed insulation fastener and tool and associated method. A nail with a clinging end, is used to fasten an insulating plate in a friable material to a wall. The end of a rod has been recessed over an axial distance being slightly bigger than the length of the clinging portion of the nail so as to release an axial boring forming an annular skirt for receiving a clinging portion of a nail of the invention, the skirt also allowing to protect it. It is through the annular slice of the end, in abutment against the propulsion collar of the nail in firing position and serving as a hammer, that the mass propels the nail into the wall to be covered with the insulating plates. This device is again constructed to shield a second end of a fastener while a first nail end is driven into a surface with a hammer. Moreover, the second fastening end is not a threaded end it is a plurality of clinging fins.

DE Application No. 2020/20002989 (Petersen) discloses a connecting element and device for handling the same. Connecting element for connecting components made of wood, wood-based materials and other materials suitable for a nail connection with one another or with non-nailable materials. The connecting element consists of a pin-shaped shaft with points the ends on both sides and/or a short bead-like thickening of the same between the ends, preferably in the center of the shaft. When using the connecting element, a device is designed in the form of a drive-in sleeve that easily fits the nail shaft ends. This device can be designed as a solid part with a bore for direct transmission of impact force to the tip located inside or as a simple pipe end for transmission of impact force to the thickening or as an attachment for a nailing device. At its open end, this can also be profiled to fit the profiled thickening in order to transmit the rotary movement to a thread on the shaft. The impact sleeve is configured to protect a second end of the connecting element, and is not designed to be countersunk into the surfaced to be joined.

JPH Application No. 04175506 (Kawamoto) discloses a double ended nail with driving device. The invention relates to a nail having points on its both ends and is bulged in the middle, inserting a driving cap which can be removed on either one end, and driving the nail together with a member to be connected in an overlapped condition. Points are provided on both sides of a collar part, and a driving cap is fitted to either one side. The nail is driven by hitting the head of the cap, then the cap is removed and a member to be connected is overlapped and driven, resulting in finishing without damage. Again this device is designed to protect a second end of the connecting element, and is not designed to be countersunk into the surfaced to be joined.

KR Application No. 20060057485A (Lee) discloses a nail. The nail body is formed with a nailing tool formed with a fastening hole capable of embedding the nail, and the blade body and the head are formed on both sides of the fastening hole of the tool and hit one side of the nailing tool to nail it to one side of the wood, then remove the tool and attach the other wood to be joined to the nail body and then hitting one side of wood.

All documents cited herein are incorporated by reference.

None of the above cited documents, alone or in combination satisfy the need for a unitary custom bit attachment that can be used to drive one end of a dual tipped fastener, using a multi-bit screw driver, or a drill, while protecting the other end of the fastener from damage. The custom bit attachment is inexpensive to manufacture, easy to use, produces a sturdy, blind join while addressing the above-mentioned deficiencies.

### BRIEF SUMMARY

It is an object of the invention to provide a system comprising dual sided fasteners, a custom bit attachment, and method of using same.

In accordance with an aspect of the invention there is provided a system to connect two surfaces, said system comprising: a custom bit attachment tool comprising; a hollow tubular portion, having a closed end and an open end, said hollow tubular portion sized and configured to accommodate an elongated second side of a dual-sided fastener; a hex bit attachment connected to said closed end of said a hollow tubular portion; and two or more connection tines extending from said open end of said a hollow tubular portion, and a dual-sided construction fastener, said dual-sided fastener comprising: an elongated first side, having a screw-threaded portion, bounded at opposing ends by a central portion and a pointed end; an elongated second side, having a second screw-threaded portion or a nail portion, bounded at opposing ends by said central portion and a second pointed end; and a central portion, comprising two or more notches sized and configured to cooperate with said connection tines on said custom bit attachment tool.

In accordance with an aspect of the invention there is provided a kit of parts for constructing a blind join, said kit comprising: one or more custom bit attachment tools, said tools comprising; a hollow tubular portion, having a closed end and an open end, said hollow tubular portion sized and configured to accommodate an elongated second side of a dual-sided fastener; a hex bit attachment connected to said closed end of said a hollow tubular portion; and two or more connection tines extending from said open end of said a hollow tubular portion, and one or more dual-sided construction fastener, said dual-sided fastener comprising: an elongated first side, having a screw-threaded portion, bounded at opposing ends by a central portion and a pointed end; an elongated second side, having a second screw-threaded portion or a nail portion, bounded at opposing ends by said central portion and a second pointed end; and a central portion, comprising two or more notches sized and configured to cooperate with said connection tines on said custom bit attachment tool.

The advantages and features of the present invention will become better understood with reference to the following more detailed description and claims taken in conjunction with the accompanying drawings in which like elements are identified with like symbols.

### BRIEF DESCRIPTION OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

FIGS. 1A and 1B illustrates side perspective aspect of the subject matter in accordance with embodiments of fasteners of the invention.

FIGS. 2A and 2B illustrate a side and partial cross-sectional aspects of the subject matter in accordance with one embodiment of the fastener of the invention.

FIG. 3 illustrates a side aspect of the subject matter in accordance with one embodiment of the invention.

FIG. 4 illustrates a side aspect of the subject matter in accordance with another embodiment of the invention.

FIGS. 5A and 5B illustrates side perspective aspect of the subject matter in accordance with alternative embodiments of fasteners of the invention.

FIGS. 6A and 6B illustrate a side and partial cross-sectional aspects of the subject matter in accordance with an alternative embodiment of the fastener of the invention.

FIG. 7 illustrates a side aspect of the subject matter in accordance with another embodiment of the invention.

FIG. 8 illustrates a side aspect of the subject matter in accordance with another embodiment of the invention.

FIGS. 9A to 9J illustrate various aspect of the fastener heads in accordance with one embodiment.

FIGS. 10A to 10D illustrate different aspects of the subject matter in accordance with the first end screw of various embodiments of the invention.

### DETAILED DESCRIPTION

The invention is a fastening method which provides a firm joint between two surfaces with the use of screws and nails. The advantage of this method over the traditional method is that it is not visible on the outside and thus improves the look of the finished product. With the use of the special drill half of the “double screw” or “screw /nail” can be firmly screwed into one of the pieces leaving the top of the screw head flushed to the piece’s surface and the other half (Nail or screw) protruding and ready for use to join the other piece together.

The term “connected”, “attached”, “affixed” or “coupled to” may include both direct coupling (in which two elements that are coupled to each other contact each other) and indirect coupling (in which at least one additional element is located between the two elements).

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

It is an object of the present invention to provide an elongate double sided construction fastener having a first end and a second end wherein the first end and the second end are capable of penetrating material to be fastened, wherein the first end and second end are joined by a screw head.

It is a further object of the present invention to provide a double-sided construction fastener wherein the first end is a screw and the second end is a nail.

It is yet a further object of the present invention to provide a double-sided construction fastener wherein the first end is a screw and the second end is a screw.

It is a still further object of the present invention to provide a double-sided construction fastener wherein the length and diameter of the first end screw and the length and diameter of the second end nail are the same.

It is another object of the present invention to provide a double-sided construction fastener wherein the length and diameter of the first end screw and the length and diameter of the second end nail are the different.

It is yet another object of the present invention to provide a double-sided construction fastener wherein the length and diameter of the first end screw and the length and diameter of the second end screw are the same.

It is a still another object of the present invention to provide a double-sided construction fastener wherein the length and diameter of the first end screw and the length and diameter of the second end screw are the different.

It is an additional object of the present invention to provide a double-sided construction fastener wherein the first end screw has a screw head with a countersunk profile.

It is a still further object of the present invention to provide an applicator tool suitable for driving the first end of the fastener into the material to be fastened, wherein the first end of the fastener is a screw.

It is a still further object of the present invention to provide an applicator tool suitable for driving the first end of the fastener into the material to be fastened, wherein the applicator tool is configured to cooperated with the screw head.

It is a still further object of the present invention to provide an applicator tool, such as a custom bit attachment, suitable for driving the first end of the fastener into the material to be fastened, wherein the applicator tool is configured to cooperated with a multibit screwdriver or a power drill.

The dual-sided fasteners as described herein, include the screw-nail fasteners and screw-screw fasteners, and cooperating custom bit tool attachments to insert the dual-sided fasteners. The uniquely designed drill bit tool has a hollow space in the center in which the protruding screw or nail can fit inside allows the crowned shaped tip of the drill bit to reach the screw head and have an interlocking connection with the notched of the screw head.

The screw-screw fastener option allows a screw thread to firmly attach to the two pieces to be joined. The final result is a tight strong connection of the two pieces with no fastening elements in sight.

Similarly, the screw-nail fastener option allows a screw thread to firmly attach at one or more positions on the first of the two surfaces or pieces to be joined. The second of the surfaces or pieces to be joined is positioned touching the nail end of the screw-nail fastener and hammered into place. The final result is a tight strong connection of the two pieces with no fastening elements in sight.

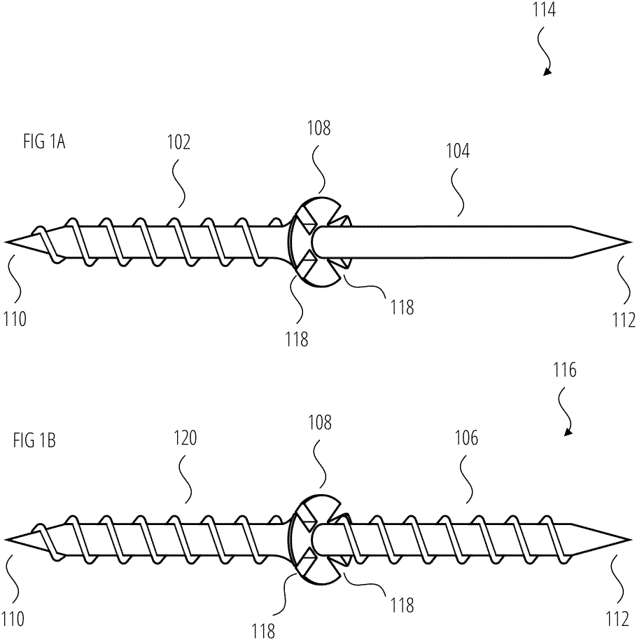

FIGS. 1A and 1B illustrate elongate double sided construction fasteners in accordance with two different embodiments of the invention.

FIG. 1A shows a screw-nail fastener 114 having a first end that is a screw end 102, and a second end that is a nail end 104. The sharp first end 110 on screw end 102, and the sharp second end 112 on the nail end 104, are situated at opposing ends of the elongate fastener and are capable of penetrating material to be fastened. The screw end 102 and nail end 104 first end and second end are joined or separated by a screw head 108.

FIG. 1B shows a screw-screw fastener 116 having a first screw end 120 and a second screw end 106. The sharp first end 110 on the first screw end 120 and the sharp second end 112 on the second screw end 106 also being situated at opposing ends of the elongate fastener and are capable of penetrating material to be fastened. The first screw end 120 and the second screw end 106 are joined or separated by a screw head 108.

In both embodiments of the invention illustrated, specifically the screw-nail fastener 114 and the screw-screw fastener 116, the screw head 108 having a series of notches 118 positioned on a horizontal top surface or extending transversely down the side of the screw head 108.

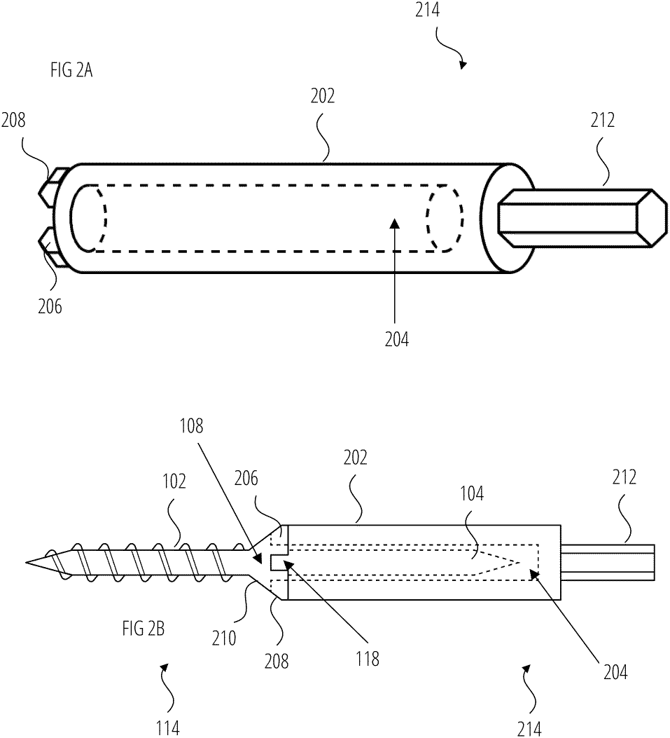

FIGS. 2A and 2B illustrate an applicator tool, such as a hex bit connector 212, showing cooperation with an embodiment of a fastener of the current invention.

FIG. 2A shows an embodiment of a hex bit connector 212 comprising a main body 202 having an essentially cylindrical shape. A hollow internal chamber 204 is sized and proportioned to accommodate either the nail end 104 of the screw-nail fastener 114 or the second screw end 106 of the screw-screw fastener 116. The hollow internal chamber 204 has a closed end that abuts a hex bit connector 212, and an open end comprising a series of outwardly extending connection tines 206. The connection tines 206 are sized and configured to cooperate with the size and shape of the notches 118 on the screw head 108.

FIG. 2B illustrates a screw-nail fastener 114 operatively associated with a hex bit connector 212. The nail end 104 of the screw-nail fastener 114 can be seen situated within the hollow internal chamber 204. The connection tines 206 that extend longitudinally from the open end of the hollow internal chamber 204 have a chamfered edge 208 in this embodiment of the invention to cooperated with a screw head 108 that has a countersunk profile 210.

In operation, the surfaces to be joined are marked up and pilot holes drilled if necessary. The screw-nail fastener 114 has the nail end 104 inserted into the hollow internal chamber 204. The connection tines 206 are engaged with the notches 118 on the screw head 108. The hex bit connector 212, on the opposing end of the main body 202 to the connection tines 206, is then inserted into a power drill of a multi-bit screw driver. The screw end 102 of the screw-nail fastener 114 is then driven into a first surface to be joined, until the upper flat side or top of the screw head 108 is flush with the first surface to be joined. The hex bit connector 212 is removed and the sharp second end 112 of the nail end 104 is then lined up with the marking on the second surface and then hammered into place.

When a screw-screw fastener 116 is used (not shown), the second screw end 106 inserted into the hollow internal chamber 204. The connection tines 206 are engaged with the notches 118 on the screw head 108. The hex bit connector 212, on the opposing end of the main body 202 to the connection tines 206, is then inserted into a power drill of a multi-bit screw driver. The first screw end 120 of the screw-screw fastener 116 is then driven into a first surface to be joined, until the upper flat side or top of the screw head 108 is flush with the first surface to be joined. The hex bit connector 212 is removed and the sharp second end 112 of the second screw end 106 is then lined up with the marking on the second surface and then the second surface is rotated around the axis defined by the screw-nail fastener 114 until the first and second surfaces are connected.

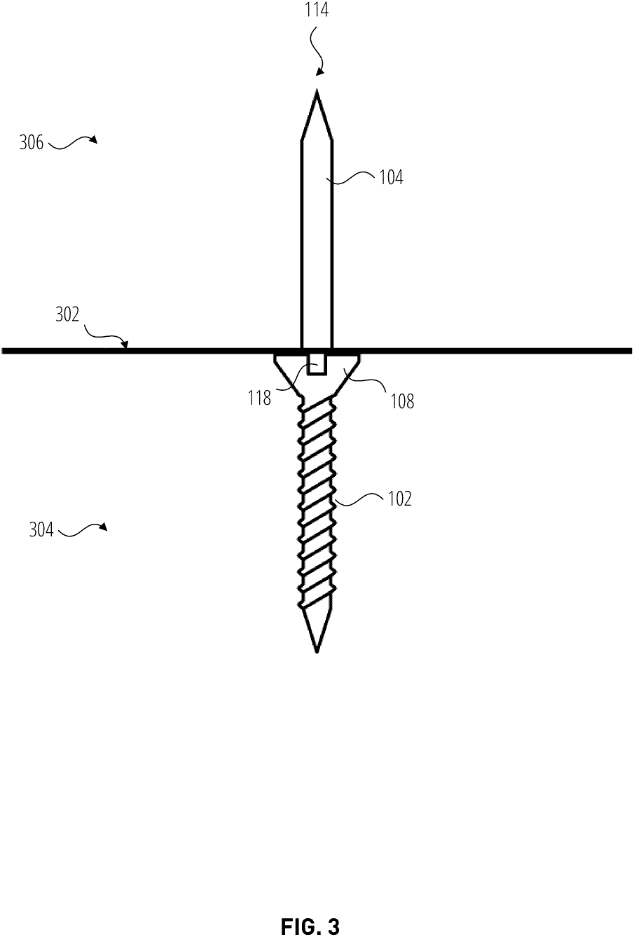

FIG. 3 illustrates a side cross-sectional view of a first surface 304 and a second surface 306 attached together using a screw-nail fastener 114. The screw end 102 of the screw-nail fastener 114 is driven into the first surface 304. The countersunk profile 210 of the screw head 108 being screwed into the first surface 304 until the top surface of the screw head 108 is flush with the first surface 304. The nail end 104 of the screw-nail fastener 114 then being driven into the second surface 306 with a hammer, to form a blind join 302.

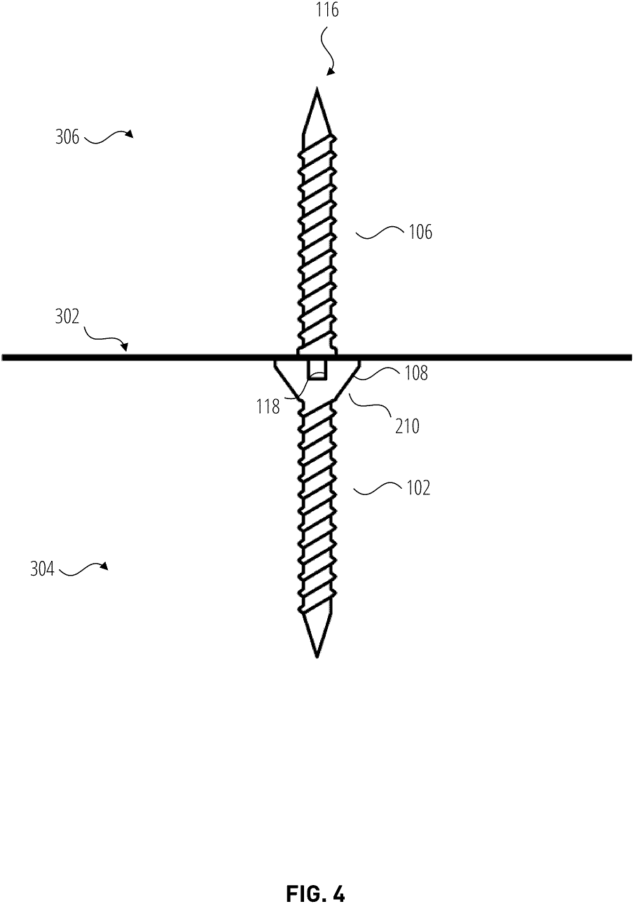

FIG. 4 illustrates a side cross-sectional view of a first surface 304 and a second surface 306 attached together using a screw-screw fastener 116. The screw end 102 of the screw-screw fastener 116 is driven into the first surface 304. The countersunk profile 210 of the screw head 108 being screwed into the first surface 304 until the top surface of the screw head 108 is flush with the first surface 304. The second screw end 106 of the screw-screw fastener 116 then being positioned and the second surface 306 is rotated around the axis defined by the screw-screw fastener 116 until the first surface 304 and second surface 306 meet forming a blind join 302.

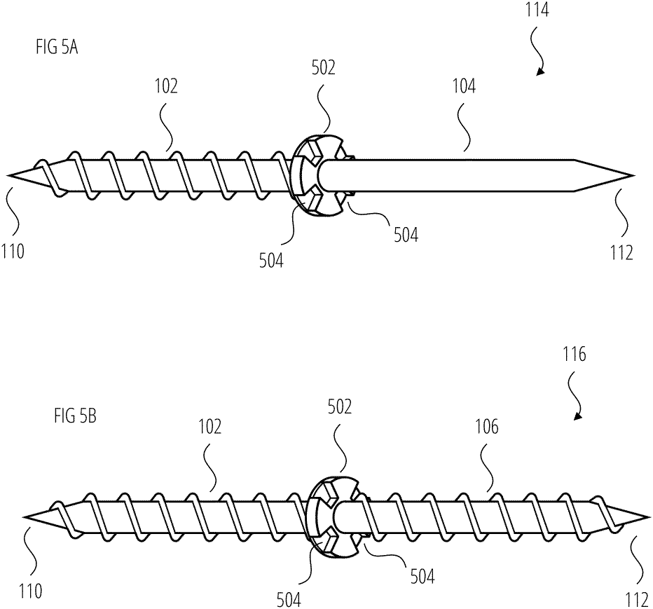

FIGS. 5A and 5B illustrate elongate double sided construction fasteners in accordance with two further embodiments of the invention.

FIG. 5A shows a screw-nail fastener 114 having a first end that is a screw end 102, and a second end that is a nail end 104. The sharp first end 110 on screw end 102, and the sharp second end 112 on the nail end 104, are situated at opposing ends of the elongate fastener and are capable of penetrating material to be fastened. The screw end 102 and nail end 104 first end and second end are joined or separated by an alternative screw head 502.

FIG. 5B shows a screw-screw fastener 116 having a first screw end 120 and a second screw end 106. The sharp first end 110 on the first screw end 120 and the sharp second end 112 on the second screw end 106 also being situated at opposing ends of the elongate fastener and are capable of penetrating material to be fastened. The first screw end 120 and the second screw end 106 are joined or separated by an alternative screw head 502.

In both embodiments of the invention illustrated, specifically the screw-nail fastener 114 and the screw-screw fastener 116, the alternative screw head 502 having a series of alternative notches 504 positioned on a horizontal top surface or extending transversely down the side of the alternative screw head 502.

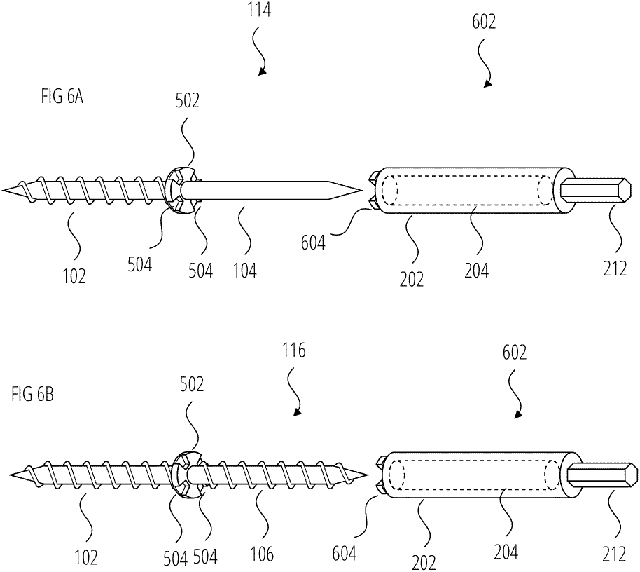

FIGS. 6A and 6B illustrate an alternative bit tool attachment 602, showing cooperation with embodiments of fasteners of the current invention.

FIG. 6A shows an embodiment of an alternative bit tool attachment 602 comprising a main body 202 having an essentially cylindrical shape. A hollow internal chamber 204 is sized and proportioned to accommodate the nail end 104 of a screw-nail fastener 114. The hollow internal chamber 204 has a closed end that abuts a hex bit connector 212, and an open end comprising a series of outwardly extending alternative tines 604. The alternative tines 604 are sized and configured to cooperate with the size and shape of the alternative notches 504 on the alternative screw head 502.

In operation, for the screw-nail fastener 114, the surfaces to be joined are marked up and pilot holes drilled if necessary. For alternative screw heads 502 that do not have a standard countersunk profile 210, it is necessary to router out a void corresponding to the profile of the alternative screw head 502 in the first surface to be joined. The screw-nail fastener 114 has the nail end 104 inserted into the hollow internal chamber 204. The alternative tines 604 are engaged with the alternative notches 504 on the alternative screw head 502. The hex bit connector 212, on the opposing end of the main body 202 to the alternative tines 604, is then inserted into a power drill of a multi-bit screw driver. The screw end 102 of the screw-nail fastener 114 is then driven into a first surface to be joined, until the upper flat side or top of the alternative screw head 502 is flush with the first surface to be joined. The hex bit connector 212 is removed and the sharp second end 112 of the nail end 104 is then lined up with the marking on the second surface and then hammered into place.

FIG. 6B shows an embodiment of an alternative bit tool attachment 602 comprising a main body 202 having an essentially cylindrical shape. A hollow internal chamber 204 is sized and proportioned to accommodate the second screw end 106 of a screw-screw fastener 116. The hollow internal chamber 204 has a closed end that abuts a hex bit connector 212, and an open end comprising a series of outwardly extending alternative tines 604. The alternative tines 604 are sized and configured to cooperate with the size and shape of the alternative notches 504 on the alternative screw head 502.

In operation, for the screw-screw fastener 116, the surfaces to be joined are marked up and pilot holes drilled if necessary. For alternative screw heads 502 that do not have a standard countersunk profile 210, it is necessary to router out a void corresponding to the profile of the alternative screw head 502 in the first surface to be joined. The screw-screw fastener 116 has the second screw end 106 inserted into the hollow internal chamber 204. The alternative tines 604 are engaged with the alternative notches 504 on the alternative screw head 502. The hex bit connector 212, on the opposing end of the main body 202 to the alternative tines 604, is then inserted into a power drill of a multi-bit screw driver. The screw end 102 of the screw-screw fastener 116 is then driven into a first surface to be joined, until the upper flat side or top of the alternative screw head 502 is flush with the first surface to be joined. The hex bit connector 212 is removed and the sharp second end 112 of the second screw end 106 is then lined up with the marking on the second surface, and then the second surface is rotated around the axis defined by the screw-screw fastener 116 until the first and second surfaces are connected.

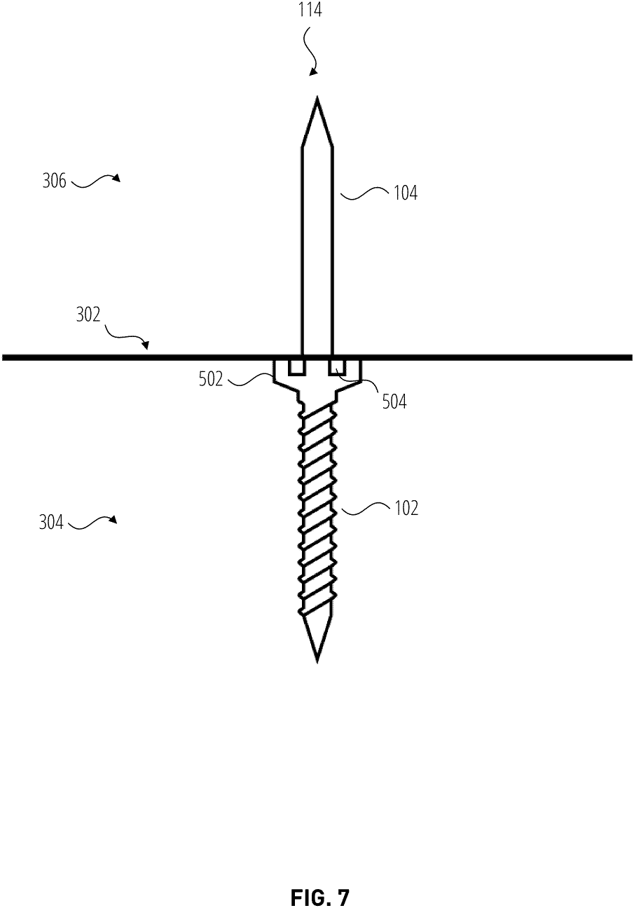

FIG. 7 illustrates a side cross-sectional view of a first surface 304 and a second surface 306 attached together using a screw-nail fastener 114. For alternative screw heads 502 that do not have a standard countersunk profile 210, it is necessary to router out a void corresponding to the profile of the alternative screw head 502 in the first surface to be joined. The screw end 102 of the screw-nail fastener 114 is driven into the first surface 304. The alternative screw head 502 being screwed into the void routered in the first surface 304 until the top surface of the alternative screw head 502 is flush with the first surface 304. The nail end 104 of the screw-nail fastener 114 then being driven into the second surface 306 with a hammer, to form a blind join 302.

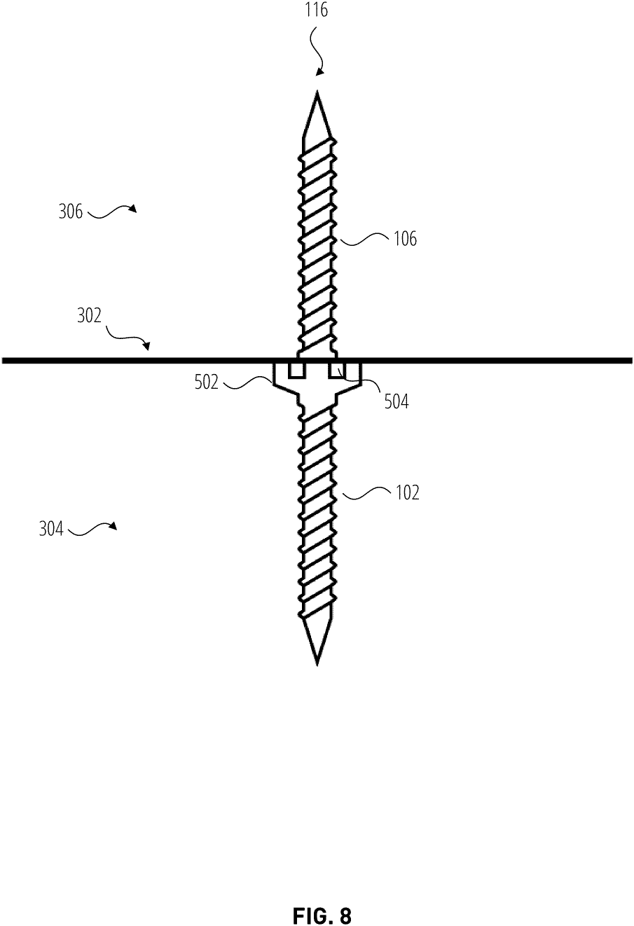

FIG. 8 illustrates a side cross-sectional view of a first surface 304 and a second surface 306 attached together using a screw-screw fastener 116. For alternative screw heads 502 that do not have a standard countersunk profile 210, it is necessary to router out a void corresponding to the profile of the alternative screw head 502 in the first surface to be joined. The screw end 102 of the screw-screw fastener 116 is driven into the first surface 304. The alternative screw head 502 being screwed into the void routered in the first surface 304 until the top surface of the alternative screw head 502 is flush with the first surface 304. The second screw end 106 of the screw-screw fastener 116 then being driven into the second surface 306 by rotating the second surface 306 around the axis defined by the screw-screw fastener 116 until the first and second surfaces are connected to form a blind join 302.

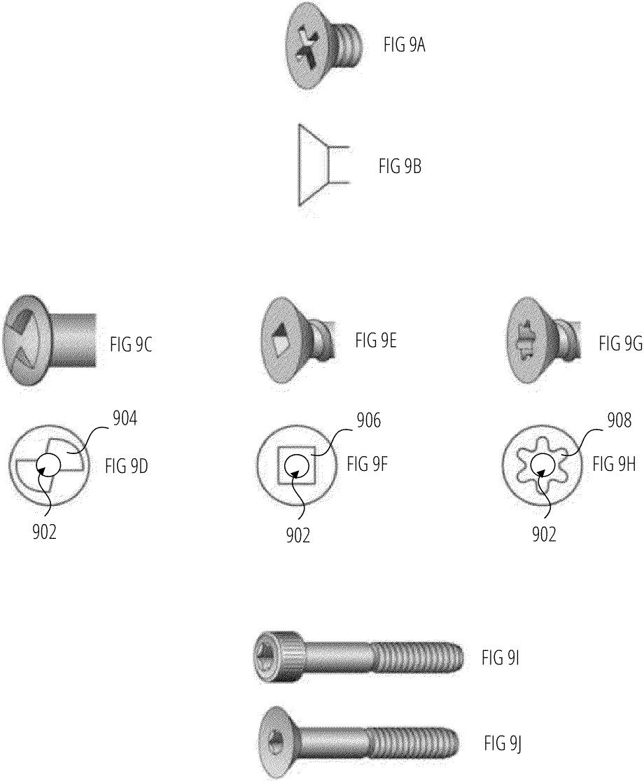

FIGS. 9A to 9J illustrate contemplated alternative screw heads that can be used in various different embodiments of the invention.

FIGS. 9A to 9H and 9J show various countersunk profiles of different alternative screw heads. FIG. 9J is an example of an alternative screw head that would require routering of the first surface prior to attachment.

FIGS. 9A, 9C, 9E, 9G, and 9J show various different notch patterns on the screw head. Consequently, the connection tines on the custom bit attachment would be configured to cooperate with the notch patterns on the screw head.

FIGS. 9D, 9F, and 9H indicate various top views of some examples of different known screw head configurations. Examples of different notch areas are indicated as a slotted notch 904, a square notch 906, and a six-lobe notch 908. The cross-sectional area 902 corresponding to either the nail end 104 or the second screw end 106 of the screw-nail fastener 114 of screw-screw fastener 116 respectively is indicated.

Embodiments of the custom bit attachment would have connecting tines that are shaped, sized and configured such that the outer surface of the connection tined operatively cooperate with the void created the slotted notch 904 the square notch 906 or the 908 and the cross-sectional area 902 of the nail end 104 of the second screw end 106 of the screw-nail fastener 114 of the screw-screw fastener 116.

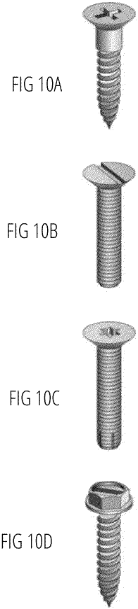

FIGS. 10A to 10D illustrate a variety of screw types that can form the screw end of the screw-nail fastener 114 or the screw-screw fastener 116. The important feature is that the head of the screw is flat. Preferably the screw thread has a countersunk profile, however different shapes can be used provided that the first surface 304 is routered to accommodate the screw head.

The dual-sided fasteners are fabricated as one-piece, unitary structures. The screw-nail fastener 114 and screw-screw fastener 116 have a central region comprising a screw head 108 or flange that effectively connects the screw end 102 to the nail end 104 or the screw end 102 to the second screw end 106. The dual-sided fasteners may be fabricated from materials that are typical of those used to fabricate nails and screws. For example, the dual-sided fasteners may be made from materials selected from, but not limited to: steel; stainless steel; copper; aluminum; and titanium. In some embodiments of the invention, the steel may be coated or plated with nickel or chromium.

With regard to the custom bit attachment 214, fabrication can be from steel (optionally chromium and nickel plated), stainless steel and titanium.

The sizes/dimension, including lengths and diameters of the screw ends 102, nail ends 104, and second screw ends 106 can be independently varied. Similarly, the custom bit attachment 214 can be sized and dimensioned to accommodate varying sizes/dimensions of the nail ends 104, or second screw ends 106.

The notches 118 on the screw heads 108, and the corresponding connection tines 206 on the custom bit attachment 214, may be configured in a variety of different shapes and patterns. These may include, but are not limited to: Phillips; slotted; hexagonal; one-way, square; tors/lobed; triangle, Y-type; 5-point; and tri-wing. Typically, the screw heads 108 are flat headed, and have a countersunk profile 210, however, various different shaped screw heads 108 that allows two surfaces to be attached to form a blind join 302.

The various parts of the different embodiments of the invention can be provided individually or as part of saleable kits. Kits can comprise a variety of differently sized custom bit attachments 214.

The embodiments described herein were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

1. A system to connect two surfaces, said system comprising:
a custom bit attachment tool comprising; a hollow tubular portion, having a closed end and an open end, said hollow tubular portion sized and configured to accommodate an elongated second side of a dual-sided fastener; a hex bit attachment connected to said closed end of said a hollow tubular portion; and two or more connection tines extending from said open end of said a hollow tubular portion, and
a dual-sided construction fastener, said dual-sided fastener comprising: an elongated first side, having a screw-threaded portion, bounded at opposing ends by a central portion and a pointed end; an elongated second side, having a second screw-threaded portion or a nail portion, bounded at opposing ends by said central portion and a second pointed end; and a central portion, comprising two or more notches sized and configured to cooperate with said connection tines on said custom bit attachment tool.

2. The system of claim 1, wherein said elongated second side is inserted into said hollow tubular portion, said two or more connection tines engaging with said two or more notches, said hex bit attachment being connected to a device that rotates said custom bit attachment, resulting in said elongated first side of said dual-sided fastener to be driven into a surface.

3. The system of claim 2, wherein, upon removal of said custom bit attachment from said elongated second side, said pointed end of said elongated second side is driven into a second surface.

4. The system of claim 2, wherein said device is a multi-bit screwdriver.

5. The system of claim 2, wherein said device is a drill.

6. The system of claim 5, wherein said drill is a power drill.

7. The system of claim 3, wherein said pointed end is driven into said second surface using a hammer to urge the second surface towards said first surface.

8. The system of claim 3, wherein said pointed end is driven into said second surface by rotating said second surface around an axis defined by said dual-sided fastener.

9. The system of claim 1, wherein said custom bit attachment tool is fabricated from steel, stainless steel, chromium plated steel, nickel plated steel, or titanium.

10. The system of claim 1, wherein said dual-sided construction fastener is fabricated from steel, stainless steel, chromium plated steel, nickel plated steel, copper, aluminum, or titanium.

11. The system of claim 1, wherein said elongated first side has a screw-threaded portion and said elongated second side has a nail portion.

12. The system of claim 1, wherein said central portion has a countersunk profile.

13. The system of claim 1, wherein said elongated first side has a screw-threaded portion and said elongated second side has a second screw-threaded portion.

14. The system of claim 1, wherein said custom bit attachment tool has two connection tines and said dual-sided construction fastener has two notches.

15. The system of claim 1, wherein said custom bit attachment tool has three connection tines and said dual-sided construction fastener has three notches.

16. The system of claim 1, wherein said custom bit attachment tool has four connection tines and said dual-sided construction fastener has four notches.

17. A kit of parts for constructing a blind join, said kit comprising:
one or more custom bit attachment tools, said tools comprising; a hollow tubular portion, having a closed end and an open end, said hollow tubular portion sized and configured to accommodate an elongated second side of a dual-sided fastener; a hex bit attachment connected to said closed end of said a hollow tubular portion; and two or more connection tines extending from said open end of said a hollow tubular portion, and
one or more dual-sided construction fastener, said dual-sided fastener comprising: an elongated first side, having a screw-threaded portion, bounded at opposing ends by a central portion and a pointed end; an elongated second side, having a second screw-threaded portion or a nail portion, bounded at opposing ends by said central portion and a second pointed end; and a central portion, comprising two or more notches sized and configured to cooperate with said connection tines on said custom bit attachment tool.

18. The kit of claim 17, wherein said kit comprises two or more custom bit attachment tools that are different lengths.

19. The kit of claim 17, wherein said kit comprises two or more custom bit attachment tools that are different diameters.

20. The kit of claim 17, wherein said kit comprises dual-sided construction fasteners having elongated second sides having a second screw-threaded portion, and dual-sided construction fasteners having elongated second sides having a nail portion.
